(19) United States
(12) Patent Application Publication
(10) Pub. No.: US 2025/0007217 A1
(43) Pub. Date: Jan. 2, 2025

(54) CONNECTOR

(71) Applicant: YAZAKI CORPORATION, Tokyo (JP)

(72) Inventor: Masahito Ozaki, Susono-shi, Shizuoka (JP)

(21) Appl. No.: 18/748,032

(22) Filed: Jun. 19, 2024

(30) Foreign Application Priority Data
Jun. 28, 2023 (JP) 2023-106208

(51) Int. Cl. H01R 13/641

(52) U.S. Cl. CPC H01R 13/641

(57) ABSTRACT

A connector includes a connector housing, and a cable assembly inserted into the connector housing. The cable assembly includes outer and inner housings. An inner face of a lid body in the inner housing is provided with a housing recessed portion which receives the protrusion of the inner terminal when the inner terminal is inserted into a normal position of the terminal accommodating chamber to enable a closing operation of the lid body to a closed position, and an interference wall portion which interferes with the protrusion of the inner terminal when the inner terminal is at a half-insertion position before the normal position of the terminal accommodating chamber to disable the closing operation of the lid body to the closed position.

### CROSS-REFERENCE TO RELATED APPLICATIONS

This application is based on and claims priority under 35 USC 119 from Japanese Patent Application No. 2023-106208 filed on Jun. 28, 2023, the contents of which are incorporated herein by reference.

### TECHNICAL FIELD

The present invention relates to a connector capable of detecting incomplete insertion of a terminal.

### BACKGROUND ART

In a state where a terminal of one connector is not properly inserted into a normal position, when the connector is fitted into a counterpart connector, terminals of both the connectors may cause a contact failure.

As a technique for preventing this, Patent Literature 1 discloses a structure in which a spring portion is provided on a terminal, an inclined wall portion is provided on an inner wall of a terminal accommodating chamber, and the spring portion of the terminal at a half-insertion position elastically contacts the inclined wall portion, thereby pushing the terminal to a proper position by a spring force.

### CITATION LIST

### Patent Literature

Patent Literature 1: JP2013-152833A

### SUMMARY OF INVENTION

However, the technique described in Patent Literature 1 has a problem that it is difficult to apply the technique to a small-sized communication connector because a dedicated spring portion needs to be provided on a terminal and the terminal tends to be large.

The present invention is made in view of the above circumstances, and an object of the present invention is to provide a connector capable of detecting, when an inner terminal is not inserted into a proper position for an inner housing, the incomplete insertion during assembly.

To achieve the above object, the connector according to the present invention has the following features.

The connector includes a connector housing, and a cable assembly inserted into the connector housing. The cable assembly includes an outer housing, an inner housing which has a terminal accommodating chamber extending in a front-rear direction and which is accommodated in the outer housing, and an inner terminal which is inserted into the terminal accommodating chamber of the inner housing from a rear side toward a front side in a state of being connected to an end of an electric wire. The inner housing includes an opening portion which is opened toward a side of an insertion path of the inner terminal, and an openable and closable lid body which closes the opening portion. The inner terminal includes a protrusion facing the opening portion when the inner terminal is inserted into the inner housing. An inner face of the lid body in the inner housing is provided with a housing recessed portion which receives the protrusion of the inner terminal when the inner terminal is inserted into a normal position of the terminal accommodating chamber to enable a closing operation of the lid body to a closed position, and an interference wall portion which interferes with the protrusion of the inner terminal when the inner terminal is at a half-insertion position before the normal position of the terminal accommodating chamber to disable the closing operation of the lid body to the closed position.

According to the present invention, half-insertion of a terminal can be detected based on whether a lid body of an inner housing is closed to a proper closed position. Accordingly, it is not necessary to provide an extra configuration such as a spring portion on the terminal, and the present invention can be easily applied to a small-sized communication connector.

The present invention has been briefly described above. Further, details of the present invention can be further clarified by reading modes (hereinafter, referred to as “embodiments”) for carrying out the invention to be described below with reference to the accompanying drawings.

### BRIEF DESCRIPTION OF DRAWINGS

FIG. 1 is an external perspective view showing a state where a connector according to an embodiment of the present invention is fitted into a counterpart connector;

FIG. 2 is an external perspective view of the connector according to the embodiment of the present invention;

FIG. 3 is a perspective view of a cable assembly used in the connector;

FIG. 4 is an external perspective view of an inner housing used for the cable assembly;

FIG. 5 is a perspective view of an electric wire with an inner terminal used for the cable assembly;

FIG. 6 is a side cross-sectional view showing a state where the inner terminal is being inserted into the inner housing;

FIG. 7 is a side cross-sectional view showing a state where the inner terminal is inserted into a normal position;

FIG. 8 is a side cross-sectional view showing a state where a lid body is closed from the state in FIG. 7;

FIG. 9 is an external side view of the state in FIG. 8;

FIG. 10 is a side cross-sectional view showing a state where insertion of the inner terminal is stopped before the normal position; and

FIG. 11 is a side cross-sectional view showing a state where the lid body is being closed in the state in FIG. 10 and is not closed to an end position.

### DESCRIPTION OF EMBODIMENTS

A specific embodiment of the present invention will be described below with reference to the drawings.

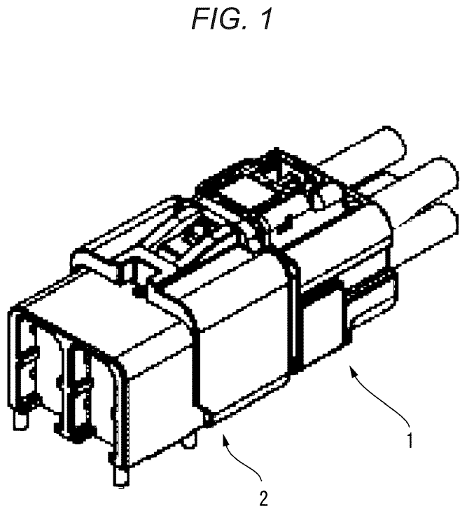

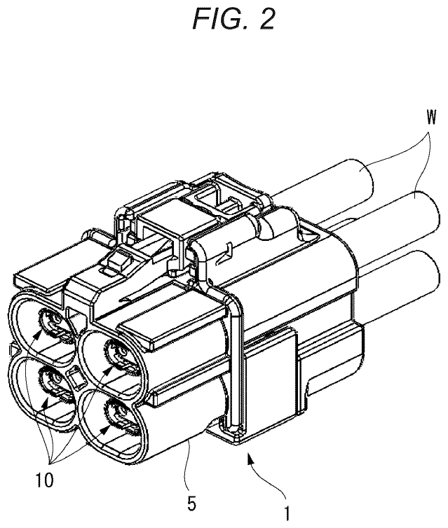

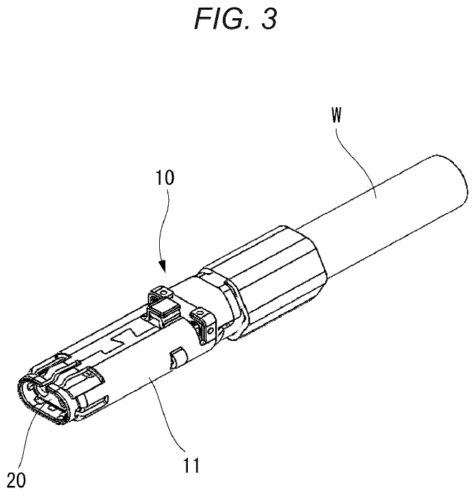

FIG. 1 is an external perspective view showing a state where a female connector 1 according to an embodiment of the present invention is fitted into a counterpart male connector 2, FIG. 2 is an external perspective view of the female connector 1 according to the embodiment, and FIG. 3 is a perspective view of a cable assembly 10 used in the female connector 1.

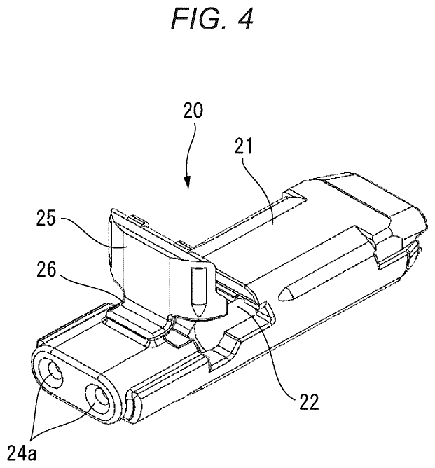

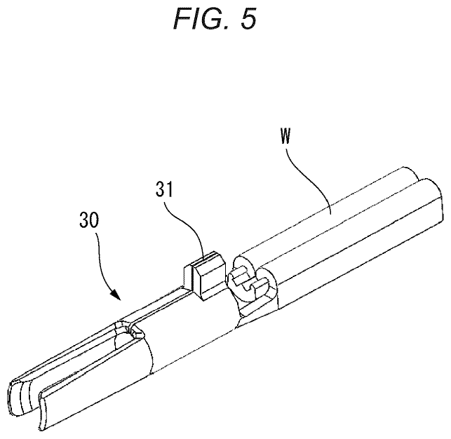

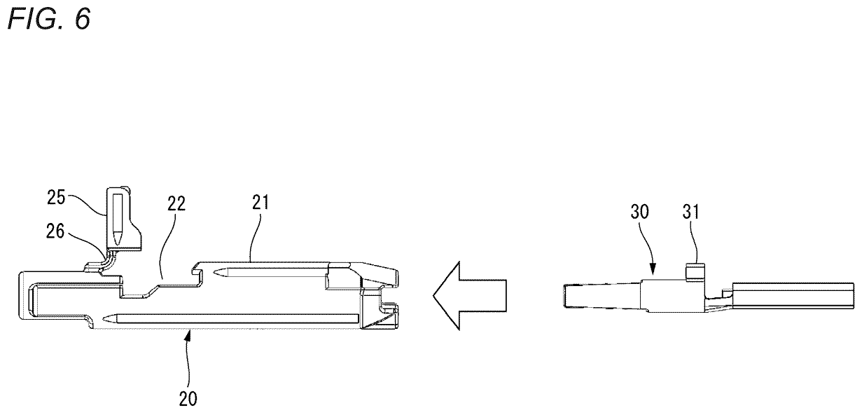

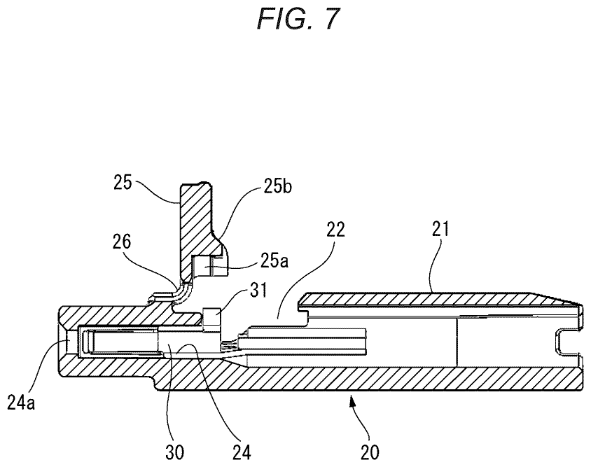

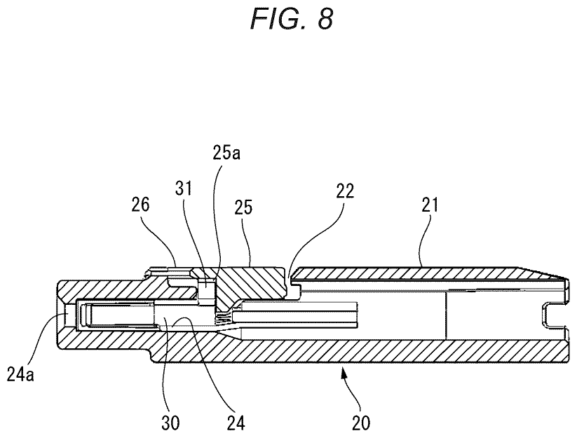

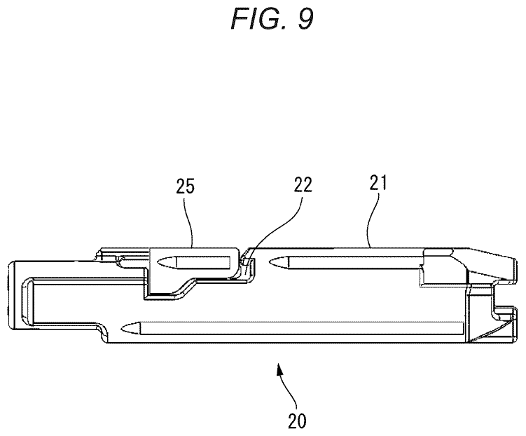

FIG. 4 is an external perspective view of an inner housing 20 used for the cable assembly 10, FIG. 5 is a perspective view of an electric wire W with an inner terminal 30 used for the cable assembly 10, FIG. 6 is a side cross-sectional view showing a state where the inner terminal 30 is being inserted into the inner housing 20, FIG. 7 is a side cross-sectional view showing a state where the inner terminal 30 is inserted into a normal position, FIG. 8 is a side cross-sectional view showing a state where a lid body 25 is closed from the state of FIG. 7, and FIG. 9 is an external side view of the state of FIG. 8.

As shown in FIG. 1, the female connector 1 according to the present embodiment is fitted into the counterpart male connector. As shown in FIG. 2, the female connector 1 includes a connector housing 5 and a plurality of the cable assemblies 10 inserted into the connector housing 5. As shown in FIGS. 3 to 5, the cable assembly 10 includes the electric wire W, an outer housing 11, the inner housing 20 accommodated in the outer housing 11, and the inner terminal 30 accommodated in the inner housing 20 in a state of being connected to an end of the electric wire W.

As shown in FIGS. 6 to 8, a terminal accommodating chamber 24 extending in a front-rear direction is provided in a body 21 of the inner housing 20, and the inner terminal 30 is inserted into the terminal accommodating chamber 24 of the inner housing 20 from the rear toward the front in a state of being connected to an end of the electric wire W. An insertion hole 24a for receiving a terminal of the counterpart male connector 2 is provided in a front end wall of the terminal accommodating chamber 24.

The body 21 of the inner housing 20 is provided with an opening portion 22 which is opened toward an upper side (lateral side) of the terminal accommodating chamber 24 which is an insertion path of the inner terminal 30, and the inner housing 20 is integrally provided with the openable and closable lid body 25 which closes the opening portion 22.

The lid body 25 is integrally coupled to the body 21 of the inner housing 20 by a hinge 26 disposed at a front end portion of the opening portion 22. By using flexibility of the hinge 26, the hinge 26 is rotatable between a position (closed position) where the opening portion 22 is reliably closed and a position where the opening portion 22 is opened. As shown in FIGS. 8 and 9, the lid body 25 is implemented such that an upper face of the lid body 25 and an upper face of the body 21 of the inner housing 20 are flush with each other by the lid body 25 being tilted to a position where the lid body 25 completely closes the opening portion 22. Accordingly, since the lid body 25 is integrally coupled to the front edge portion of the opening portion 22 of the body 21 of the inner housing 20 via the hinge 26, the body 21 and the lid body 25 of the inner housing 20 can be easily manufactured by integral molding of resin.

On the other hand, as shown in FIGS. 6 to 8, the inner terminal 30 is provided with a protrusion 31 facing the opening portion 22 when the inner terminal 30 is inserted into the terminal accommodating chamber 24 of the inner housing 20. In addition, as shown in FIGS. 7 and 8, an inner face of the lid body 25 of the inner housing 20 is provided with a housing recessed portion 25a that receives the protrusion 31 of the inner terminal 30 when the inner terminal 30 is inserted into a normal position of the terminal accommodating chamber 24, thereby enabling a closing operation of the lid body 25 to the closed position.

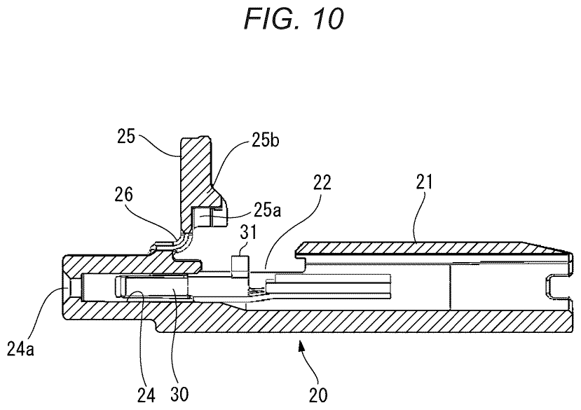

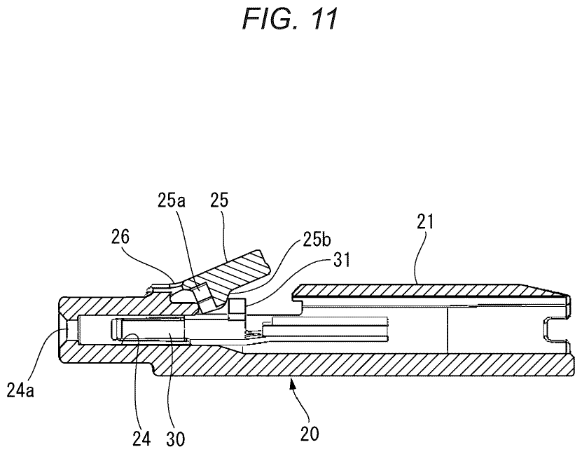

FIG. 10 is a side cross-sectional view showing a state where insertion of the inner terminal 30 is stopped before the normal position, and FIG. 11 is a side cross-sectional view showing a state where the lid body 25 is being closed in the state in FIG. 10 and is not closed to an end position.

As shown in FIGS. 10 and 11, the inner face of the lid body 25 of the inner housing 20 is provided with an interference wall portion 25b which is adjacent to the housing recessed portion 25a of the protrusion 31 of the inner terminal 30, and which interferes with the protrusion 31 of the inner terminal 30 when the inner terminal 30 stays at a half-insertion position before the normal position of the terminal accommodating chamber 24 to disable the closing operation of the lid body 25 to the closed position.

Next, an operation will be described. When the connector 1 is assembled, first, the inner terminal 30 connected to the end of the electric wire W is inserted from the rear to the front into the terminal accommodating chamber 24 of the inner housing 20. At this time, as shown in FIGS. 7 and 8, when the inner terminal 30 is inserted into the normal position of the terminal accommodating chamber 24 of the inner housing 20, the lid body 25 of the inner housing 20 can be closed to the closed position where the lid body 25 completely closes the opening portion 22. That is, the protrusion 31 of the inner terminal 30 inserted into a proper position is located at a front side position in an insertion direction and is received in the housing recessed portion 25a on the inner face of the lid body 25 without interfering with the interference wall portion 25b on the inner face of the lid body 25, so that the lid body 25 can be closed to the proper closed position. Accordingly, since the upper face of the closed lid body 25 is flush with the upper face of the body 21 of the inner housing 20, it is possible to know that the inner terminal 30 is inserted into the proper position. In addition, since the lid body 25 does not protrude to the outside of the inner housing 20, the inner housing 20 can be accommodated in the outer housing 11 without difficulty.

On the other hand, when the inner terminal 30 is not inserted into the normal position in the terminal accommodating chamber 24 of the inner housing 20, as shown in FIG. 10, a position of the protrusion 31 of the inner terminal 30 is shifted to a rear side of the normal position (compared with FIG. 7). Therefore, as shown in FIG. 11, the protrusion 31 interferes with the interference wall portion 25b of the lid body 25 of the inner housing 20, and the lid body 25 is not closed to the closed position. That is, since the lid body 25 is not closed, the lid body 25 protrudes to the outside of the inner housing 20, and it can be detected that the inner terminal 30 is in a half-insertion state based on deformation of the external appearance thereof. In addition, even in a case where a user is not aware of the deformation of the external appearance, the inner housing 20 cannot be accommodated in the outer housing 11 because the lid body 25 protruding outward becomes an obstacle in the shape as it is. This also makes it possible to detect that the inner terminal 30 is in the half-insertion state.

Accordingly, by leaving the inner terminal 30 in the half-insertion state, a contact failure between the terminals when connected to the counterpart male connector 2 can be avoided. Accordingly, it is possible to detect whether incomplete insertion of the inner terminal 30 occurs based on the position of the lid body 25 of the inner housing 20 that interferes with the protrusion 31 of the inner terminal 30. Therefore, an assembly failure can be prevented with a simple configuration, and a contact failure between the terminals at the time of fitting the connector can be avoided. Accordingly, the present invention can be easily applied to a small-sized communication connector.

Here, features of the connector according to the embodiment of the present invention described above are briefly summarized and listed in the following [1] and [2]. [1] A connector (1) includes:
a connector housing (5); and
a cable assembly (10) inserted into the connector housing, in which
the cable assembly includes an outer housing (11), an inner housing (20) which has a terminal accommodating chamber (24) extending in a front-rear direction and which is accommodated in the outer housing, and an inner terminal (30) which is inserted into the terminal accommodating chamber of the inner housing from a rear side toward a front side in a state of being connected to an end of an electric wire (W),
the inner housing includes an opening portion (22), which is opened toward a side of an insertion path of the inner terminal, and an openable and closable lid body (25) which closes the opening portion,
the inner terminal includes a protrusion (31) facing the opening portion when the inner terminal is inserted into the inner housing, and
   an inner face of the lid body of the inner housing is provided with a housing recessed portion (25a) which receives the protrusion of the inner terminal when the inner terminal is inserted into a normal position of the terminal accommodating chamber to enable a closing operation of the lid body to a closed position, and an interference wall portion (25b) which interferes with the protrusion of the inner terminal when the inner terminal is at a half-insertion position before the normal position of the terminal accommodating chamber to disable the closing operation of the lid body to the closed position.

According to the connector (1) having the configuration of [1], when the inner terminal (30) is inserted into the normal position of the terminal accommodating chamber (24) of the inner housing (20), the lid body (25) of the inner housing is closed to the closed position where the lid body (25) completely closes the opening portion (22). On the other hand, when the inner terminal is not inserted into the normal position, the protrusion (31) of the inner terminal interferes with the lid body (25) of the inner housing, so that the lid body is not closed to the closed position. That is, since the lid body is not closed, the lid body protrudes to the outside of the inner housing, and it is detected that the inner terminal is in the half-insertion state based on the deformation of the external appearance thereof or based on a fact that the lid body becomes an obstacle in the shape as it is and the inner housing cannot be accommodated in the outer housing. Accordingly, by leaving in the half-insertion state, a contact failure between the terminals when connected to the counterpart connector can be avoided.

[2] In the connector according to [1],
the lid body is integrally and rotatably coupled to a front edge portion of the opening portion of a body of the inner housing via a hinge (26).

According to the connector having the configuration of [2], since the lid body is integrally coupled to the front edge portion of the opening portion of the body of the inner housing via the hinge (26), the body and the lid body of the inner housing can be easily manufactured by integral molding of resin.

The present invention is not limited to the embodiment described above, and can be appropriately modified, improved, or the like. In addition, materials, shapes, sizes, numbers, arrangement positions, or the like of components in the embodiment described above are freely selected and are not limited as long as the present invention can be implemented.

What is claimed is:

1. A connector comprising:
a connector housing; and
a cable assembly inserted into the connector housing, wherein
the cable assembly includes
an outer housing,
an inner housing which has a terminal accommodating chamber extending in a front-rear direction and which is accommodated in the outer housing, and
an inner terminal which is inserted into the terminal accommodating chamber of the inner housing from a rear side toward a front side in a state of being connected to an end of an electric wire,
the inner housing includes an opening portion which is opened toward a side of an insertion path of the inner terminal, and an openable and closable lid body which closes the opening portion,
the inner terminal includes a protrusion facing the opening portion when the inner terminal is inserted into the inner housing, and
an inner face of the lid body in the inner housing is provided with a housing recessed portion which receives the protrusion of the inner terminal when the inner terminal is inserted into a normal position of the terminal accommodating chamber to enable a closing operation of the lid body to a closed position, and an interference wall portion which interferes with the protrusion of the inner terminal when the inner terminal is at a half-insertion position before the normal position of the terminal accommodating chamber to disable the closing operation of the lid body to the closed position.

2. The connector according to claim 1, wherein
the lid body is integrally and rotatably coupled to a front edge portion of the opening portion of a body of the inner housing via a hinge.
